(19) United States
(12) Patent Application Publication
(10) Pub. No.: US 2005/0084828 A1
(43) Pub. Date: Apr. 21, 2005

(54) Apparatus and method for braille instruction

(75) Inventors: Richard L. Goldberg, Chapel Hill, NC (US); Randal T. Cole, Efland, NC (US); Arielle Drummond, Durham, NC (US); Diane M. Brauner, Pittsboro, NC (US)

Correspondence Address: JENKINS & WILSON, PA, 3100 TOWER BLVD, SUITE 1400, DURHAM, NC, 27707, US

(73) Assignee: The University of North Carolina at Chapel Hill

(21) Appl. No.: 10/689,796

(22) Filed: Oct. 21, 2003

(51) Int. Cl. G09B 21/00

(52) U.S. Cl. 434/112

(57) ABSTRACT

An apparatus for use in instructing a user to communicate in Braille includes a frame, a plurality of tactile switching devices, a pair of arms pivotably coupled to the frame, and electronic circuitry supported by the frame. Each switching device can have a raised position or otherwise be activated to emulate a raised Braille dot. Each arm supports at least three of the tactile switching devices. The arms are rotatable along the frame between a first position at which the switching devices are arranged in a 3×2 array of Braille dots for emulating a Braille cell, and a second position at which the arms are pivoted outwardly from each other in a 1×6 row of Braille dots for emulating a Braille writer. The electronic circuitry communicates with the switching devices for producing an auditory output in response to a combination of switching devices selectively activated by the user. The auditory output corresponds to a Braille character represented by the combination of activated switching devices.

### GOVERNMENT INTEREST

This invention was made with Government support under Grant No. BES-9981867 awarded by the National Science Foundation. The Government has certain rights in the invention.

### TECHNICAL FIELD

The present disclosure generally relates to instructing blind and visually impaired persons how to read and write Braille. More particularly, the present disclosure relates to an apparatus and method for facilitating the learning of Braille using tactile and auditory information.

### BACKGROUND ART

Braille is an essential tool of communication for blind and visually impaired persons. Generally, Braille is a system of writing in which each character is formed from a 3×2 (three rows and two columns) array or cell of Braille dots or points. Each character is distinguished by a specific pattern of raised and non-raised dots of the 3×2 cell. To enable blind and visually impaired persons to write in Braille in a manner similar to a typewriter, Braille writers are commercially available that include a single-row, 1×6 keyboard, and often other input keys such as a space bar. Conceptually, the 1×6 keyboard corresponds to a 3×2 Braille cell, with the two columns of the cell rotated upwardly and outwardly away from each other to form the single, six-dot row. To form an imprint of a 3×2 Braille character on paper, the user of a Braille writer must simultaneously push the specific combination of keys of the keyboard that will cause the Braille writer to form the pattern of raised dots corresponding to the intended Braille character.

Unfortunately, the Braille system and the technique for using the Braille writer are difficult to learn, especially for preschool and elementary age children. It has been found that commercially available Braille training devices fail to engender sufficient interest for learning. As a result, children quickly become bored and require constant supervision when using conventional Braille learning tools. Many commercial Braille trainers, such as the popular swing cell instrument commonly used to teach Braille students how to read and write Braille, do not provide auditory feedback. A typical swing cell instrument includes two wooden arms that are either freely movable or pivotably coupled to a base. Each arm has three holes. The arms can be moved so as to be adjacent and parallel to each other, such that the holes of the arms emulate the 3×2 Braille cell. The arms can also be rotated or pivoted away from each other so as to emulate the 1×6 keyboard of a Braille writer. In use, the student places pegs in the holes corresponding to the Braille character requested by the instructor, with each peg corresponding to a raised Braille dot. It is widely known among therapists, teachers, parents, and students that these pegs can easily be, and often do become, lost. Moreover, it has been found that the conventional swing cell instrument does not afford sufficient motivation for Braille students, and children in particular.

Some commercially available Braille training instruments providing auditory feedback do exist, but are considered to be too complex or advanced for young children who are just learning to read and write Braille, and/or fail to maintain a sufficient degree of motivation and interest in the learning process. Examples of Braille training instruments that provide a sound output are disclosed in U.S. Pat. Nos. 5,154,614 and 5,902,112. Unlike the swing cell instrument just described, these feedback-capable instruments cannot be switched between a mode that teaches actual 3×2 Braille characters and a mode that teaches the use of the Braille writer keyboard. Moreover, the buttons or keys provided with these instruments fail to provide proper tactile feedback that would be useful in distinguishing between raised and non-raised Braille dots. For example, in one known device that provides auditory feedback in response to the keying operations of a student, the keys or buttons provided are momentary in nature and thus not capable of maintaining more than one elevation. That is, once a student presses and releases a key, the key immediately pops back up to its original position and thus fails to provide tactile information regarding the Braille character formed or attempted to be formed by the student.

It would therefore be desirable to provide an apparatus and method for Braille instruction that renders the learning process more enjoyable, interesting and motivational, provides both tactile and auditory stimuli or feedback, provides instruction in both the formation of Braille-based alphanumeric characters and the use of the keyboard typically employed in manual Braille writers, reduces the degree of oversight required from an instructor, conditions finger movements, and/or provides other advantages.

### SUMMARY

According to one embodiment, an apparatus is provided for use in instructing a user to communicate in Braille. The apparatus comprises a frame, a plurality of tactile switching devices mounted at the frame, and electronic circuitry supported by the frame. Each tactile switching device is depressible by the user between a raised position for emulating a raised Braille dot and a lowered position. The electronic circuitry comprises an audio output device. The circuitry communicates with the switching devices for producing an auditory output for emission by the audio output device in response to a combination of switching devices selectively activated by a user. The auditory output corresponds to the Braille character represented by the combination of activated switching devices.

According to one aspect of this embodiment, the circuitry comprises a control device and a playback device. The control device receives a user input produced by the combination of switching devices selectively activated by the user, and sends a control signal based on the user input received. The playback device stores a plurality of different auditory outputs, receives the control signal sent from the control device, and sends a selected auditory output to the audio output device based on the control signal received from the control device.

According to another embodiment, an apparatus is provided for use in instructing a user to communicate in Braille. The apparatus comprises a frame, a plurality of switching devices, a pair of arms, and electronic circuitry. The switching devices can be selectively activated by a user to represent one or more raised Braille dots. The pair of arms are pivotably coupled to the frame. Each arm supports at least three of the switching devices. The pair of arms are rotatable along the frame between a first position at which the arms are generally in parallel relation and the switching devices are arranged in a 3×2 array of Braille dots for emulating a Braille cell, and a second position at which the arms are pivoted outwardly from each other in a 1×6 row of Braille dots for emulating a Braille writer. The electronic circuitry is supported by the frame and comprises an audio output device. The circuitry communicates with the switching devices for producing an auditory output for emission by the audio output device in response to a combination of switching devices selectively activated by a user. The auditory output corresponds to the Braille character represented by the combination of activated switching devices.

According to yet another embodiment, an apparatus is provided for use in instructing a user to communicate in Braille. The apparatus comprises a frame, a plurality of tactile switching devices, a pair of arms, and electronic circuitry. Each tactile switching device is depressible between a lowered position and a raised position. The pair of arms are pivotably coupled to the frame. Each arm supports at least three of the tactile switching devices. At its raised position, at least a portion of the switching device is raised above an upper surface of its corresponding arm for emulating a raised Braille dot. The pair of arms are rotatable along the frame between a first position at which the arms are generally in parallel relation and the switching devices are arranged in a 3×2 array of Braille dots for emulating a Braille cell, and a second position at which the arms are pivoted outwardly from each other in a 1×6 row of Braille dots for emulating a Braille writer. The electronic circuitry is supported by the frame and comprises an audio output device. The circuitry communicates with the switching devices for producing an auditory output for emission by the audio output device in response to a combination of switching devices selectively activated by a user. The auditory output corresponds to the Braille character represented by the combination of activated switching devices.

In a method for instructing a person in communicating in Braille, a plurality of tactile switching devices are provided. Each switching device is actuatable between a raised position that can be sensed by a person as a raised Braille dot and a lowered position that can be sensed as the absence of a raised Braille dot. In response to a combination of switching devices actuated into respective raised positions, an auditory output is provided for the person corresponding to the Braille character represented by the combination of switching devices actuated.

In another method for instructing a person in communicating in Braille, a pair of arms are provided. Each arm supports at least three tactile switching devices. The switching devices can be sensed by touch and selectively actuated for emulating patterns of raised Braille dots. The pair of arms are rotated between a first position and a second position. At the first position, the arms are generally in parallel relation and the switching devices are arranged in a 3×2 array of Braille dots for emulating a Braille cell. At the second position, the arms are pivoted outwardly from each other in a 1×6 row of Braille dots for emulating a Braille writer. In response to a combination of switching devices actuated, an auditory output is provided for the person indicative of a Braille character corresponding to the combination of switching devices actuated.

It is therefore an object to provide an apparatus and method for Braille instruction.

An object having been stated hereinabove, and which is addressed in whole or in part by embodiments disclosed herein, other objects will become evident as the description proceeds when taken in connection with the accompanying drawings as best described hereinbelow.

### BRIEF DESCRIPTION OF THE DRAWINGS

FIG. 1A is a top perspective view of an apparatus for Braille instruction according to an embodiment disclosed herein, in which the apparatus is in a read mode;

FIG. 1B is a top perspective view of the apparatus for Braille instruction, in which the apparatus is in a write mode;

FIG. 2 is a side elevation view of the apparatus for Braille instruction;

FIG. 3 is a rear elevation view of the apparatus for Braille instruction;

FIG. 4 is a bottom plan view of the apparatus for Braille instruction;

FIGS. 5A and 5B are respective schematic views of a pushbutton-actuated switch provided with the apparatus for Braille instruction, illustrated in raised and lowered positions;

FIG. 6A is a side elevation view of the pushbutton switch;

FIG. 6B is a bottom plan view of the pushbutton switch;

FIG. 7A is a perspective view of a swing arm provided with the apparatus for Braille instruction;

FIG. 7B is a partially cutaway side elevation view of the apparatus for Braille instruction, illustrating the swing arm mounted thereto; and

FIG. 8 is a schematic diagram of electronic circuitry provided with the apparatus for Braille instruction.

### DETAILED DESCRIPTION

As used herein, the term “character” generally means a letter, number, punctuation mark, abbreviation, pluralities thereof, or combinations thereof.

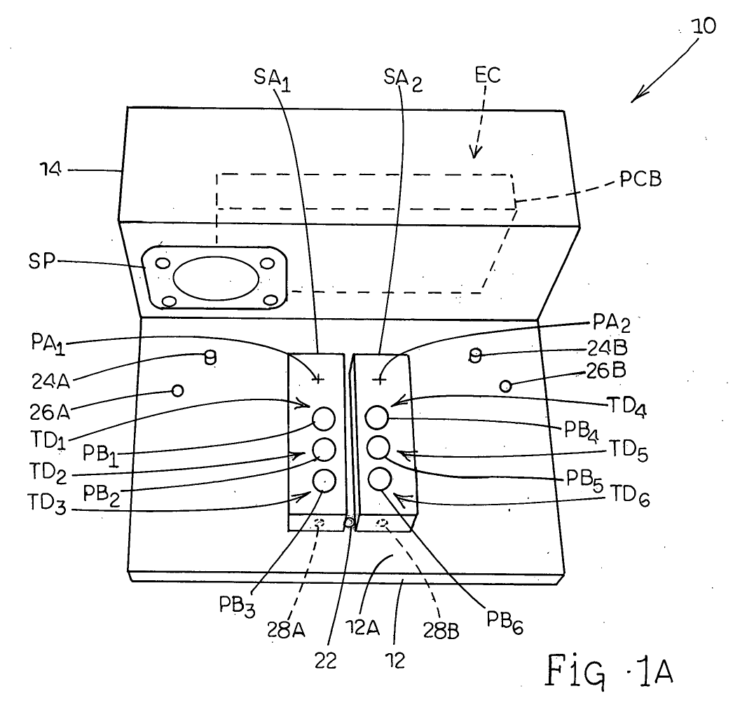

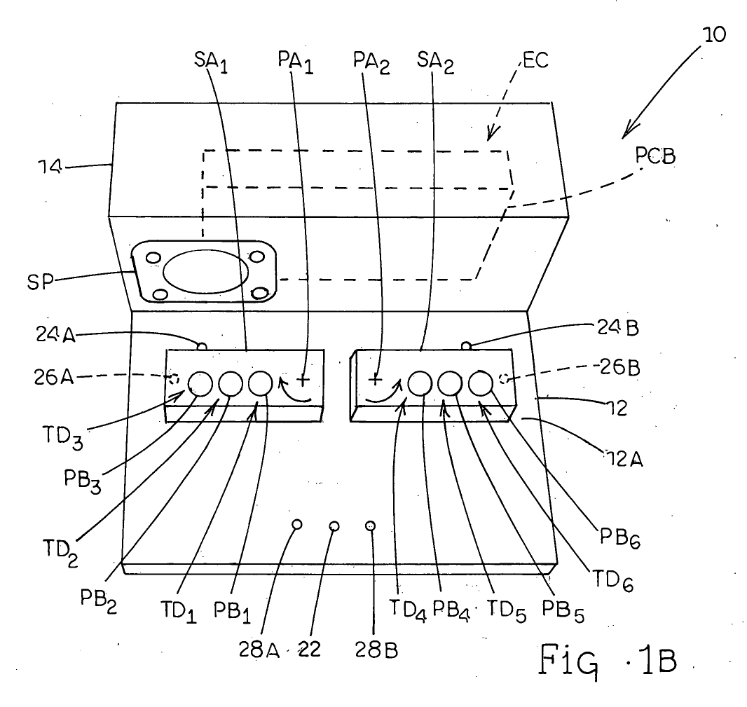

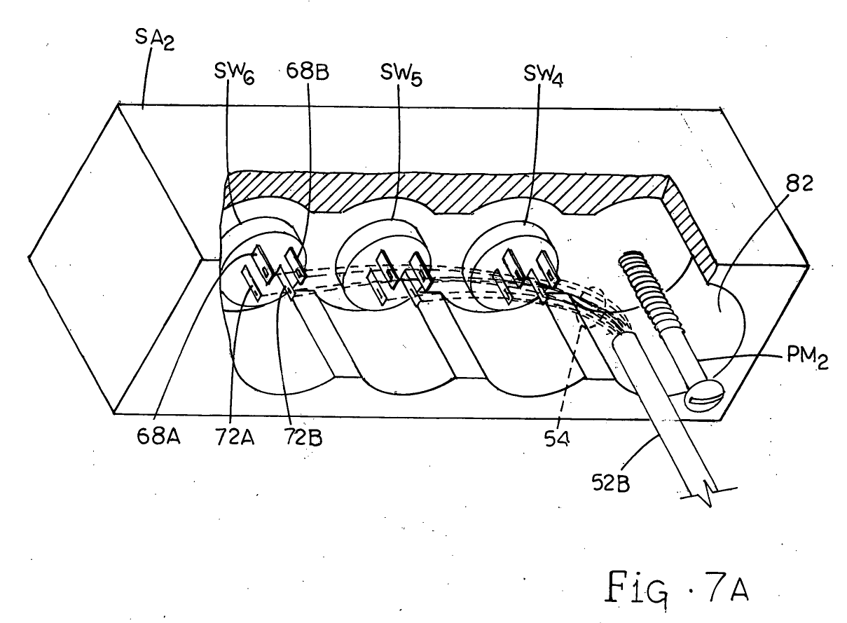

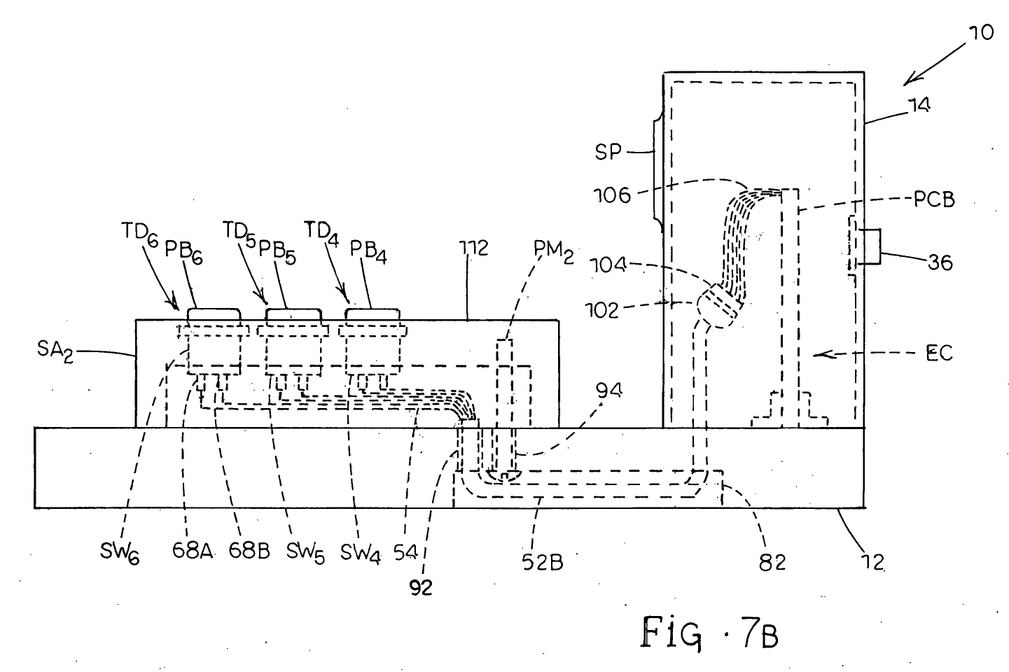

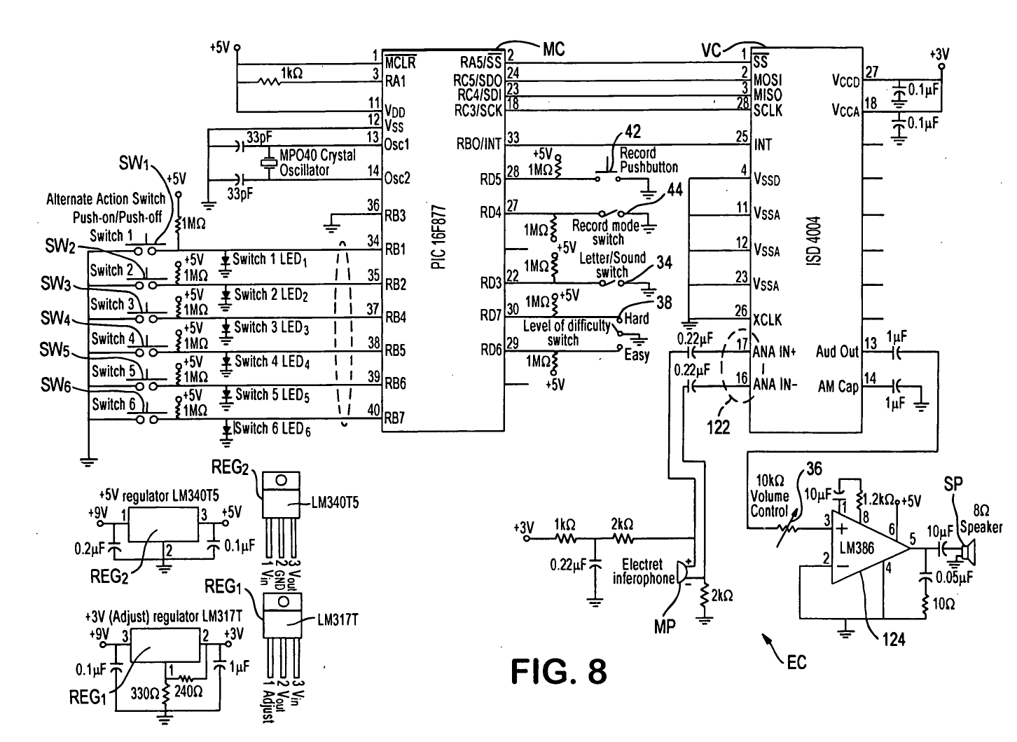

Referring now to FIGS. 1A and 1B, an apparatus for instructing persons in reading and writing Braille, generally designated 10, is illustrated according to one embodiment. Apparatus 10 comprises a frame for mounting or otherwise supporting a plurality of tactile switching devices, generally designated TD₁-TD₆; a pair of swing arms SA₁ and SA₂; and a suitable audio output component such as a speaker SP. In addition, the frame can be employed for mounting and/or enclosing electronic circuitry, generally designated EC (see also FIG. 8), such as embodied in a printed circuit board PCB, and for mounting controls as described below. In the exemplary embodiment, the frame includes a base 12 on which tactile switching devices TD₁-TD₆ and swing arms SA₁ and SA₂ are disposed, and an enclosure 14 for housing electronic circuitry EC. Swing arms SA₁ and SA₂ are pivotably coupled to base 12 at respective pivot axes P₁ and PA₂ by any suitable means for enabling swing arms SA₁ and SA₂ to rotatably move on, over or along an upper surface 12A of base 12, as generally indicated by arrows in FIG. 1B. The terms “on”, “over” and “along” are used interchangeably herein to indicate that, during pivoting, swing arms SA₁ and SA₂ can either slide in contact with upper surface 12A, or be spaced by a small distance above and thus not actually contact upper surface 12A other than at the connection made through pivot axes PA₁ and PA₂. Pivot axes PA₁ and PA₂ can represent any means for pivotably coupling swing arms SA₁ and SA₂ to base 12, such as pins, dowels, screws, bolts or other pivot members PM extending into base 12, as shown by way of example in FIGS. 7A and 7B.

As indicated above, apparatus 10 comprises a set of tactile switching devices TD₁-TD₆. Tactile switching devices TD₁-TD₆ are mounted at the frame for manipulation by a user of apparatus 10. In the advantageous embodiment illustrated herein, apparatus 10 additionally comprises swing arms SA₁ and SA₂. Two sets of three tactile switching devices, TD₁-TD₃ and TD₄-TD₆ , are respectively mounted to swing arms SA₁ and SA₂ in a generally linearly spaced-apart relation, for a total of six tactile switching devices TD₁-TD₆. The sets of tactile switching devices TD₁-TD₃ and TD₄-TD₆ comprise corresponding sets of pushbuttons PB₁-PB₃ and PB₄-PB₆ for manipulation by the user, and pushbutton switches SW₁-SW₃ and SW₄-SW₆ (see FIGS. 6A-8) that are actuable in response to manipulation of respective pushbuttons PB₁-PB₃ and PB₄-PB₆. Tactile switching devices TD₁-TD₆, and their respective pushbuttons PB₁-PB₆ and pushbutton switches SW₁-SW₆ are described in more detail below.

Swing arms SA₁ and SA₂ can be pivoted between a “read” position as shown in FIG. 1A and a “write” position as shown in FIG. 1B. The read position can be characterized as a “rotated down” position in which swing arms SA₁ and SA₂ are vertically oriented (from the perspective of FIG. 1A) in parallel and in close adjacency to each other. In the read position, pushbuttons PB₁-PB₆ of tactile switching devices TD₁-TD₆ are arranged in a 3×2 array so as to emulate an enlarged Braille cell that can be easily sensed by touch by a student, with each pushbutton PB₁-PB₆ representing a point or dot of the Braille cell. The write position can be characterized as a “rotated out” position in which swing arms SA₁ and SA₂ are horizontally oriented (from the perspective of FIG. 1B), and pushbuttons PB₁-PB₆ are arranged in a single 1×6 row so as to emulate the keyboard of a Braille (e.g., Perkins) writing instrument. A peg, dowel, or other protrusion 22 can extend upwardly from upper surface 12A of base 12 to provide a stopping mechanism for swing arms SA₁ and SA₂. This protrusion 22 limits the extent of pivoting movement of swing arms SA₁ and SA₂ into the read position and maintains the proper position of swing arms SA₁ and SA₂ relative to each other. Similarly, other protrusions 24A and 24B can be mounted to base 12 to provide the stopping/positioning function when pivoting swing arms SA₁ and SA₂ into a write position, respectively. In addition, stops 26A, 26B and 28A, 28B can be mounted to base 12 as shown in FIGS. 1A and 1B for contacting any surface of respective swing arms SA₁ and SA₂ (frictional contact, for example) to assist in retaining swing arms SA₁ and SA₂ in their proper positions.

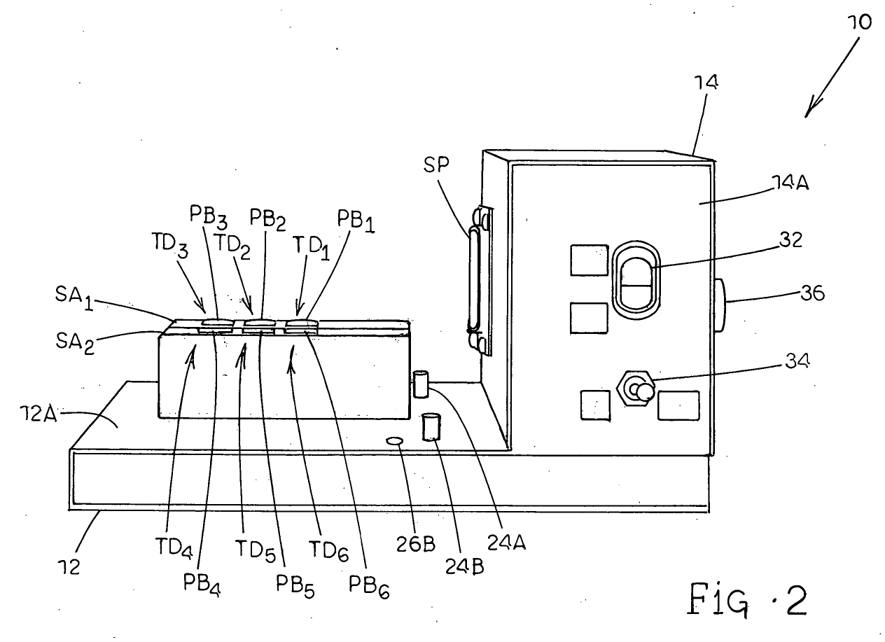

Referring to FIG. 2, in some embodiments, some of the controls for apparatus 10 can be mounted at a lateral side 14A of enclosure 14. In the example illustrated in FIG. 2, an ON/OFF power switch 32 for apparatus 10 and an audio output selector switch 34 are mounted at this lateral side 14A. Audio output selector switch 34 can have two or more settings to enable the selection of different types of auditory outputs or combinations of outputs responsive to a student's manipulation of pushbuttons PB₁-PB₆ on swing arms SA₁ and SA₂. For example, in response to manipulating pushbuttons PB₁-PB₆ to form the Braille character for the letter “a”, audio output selector switch 34 in one position could cause apparatus 10 to playback a pronunciation of the letter “a” through speaker SP, and in another position could enable apparatus 10 to play back not only a pronunciation of the letter “a” but also a word beginning with the letter “a” (e.g., “apple”) and/or a sound associated with such word (e.g., <crunch>).

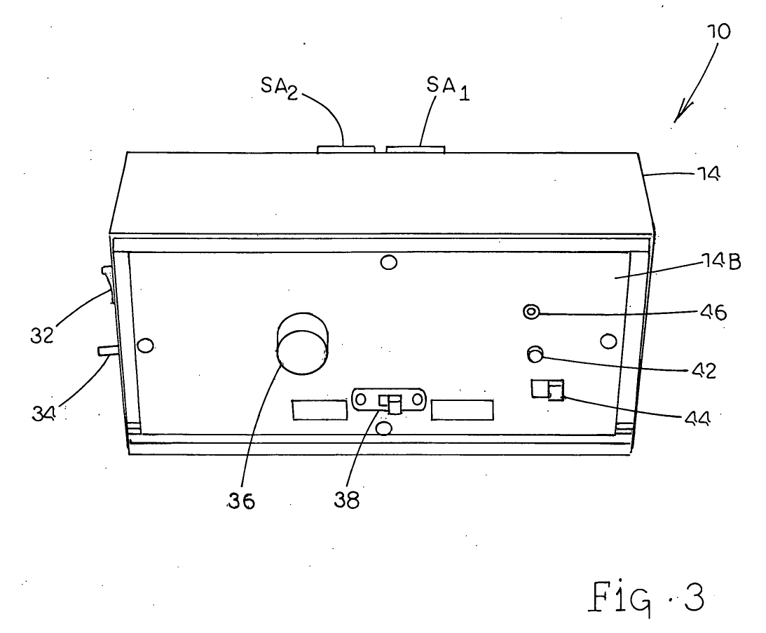

Referring to FIG. 3, other controls for apparatus 10 can be mounted at a rear side 14B of enclosure 14, i.e., the side of enclosure 14 farthest away from where a student would be sitting. In the example illustrated in FIG. 3, a volume control 36 for speaker SP (FIGS. 1A and 1B), a time delay switch 38, a record button 42, a record/playback mode switch 44, and a suitable auditory input connection such as an audio jack 46 are mounted at rear side 14B. Volume control 36 controls the gain of the output of speaker SP, and preferably is mounted to rear side 14B as illustrated so as to discourage the student from adjusting the volume level set by an instructor or parent.

Time delay switch 38 can enable two or more time delay settings for determining the period of time between the occurrence of an audio prompt directed to the student through speaker SP and the completion of the student's response through manipulation of tactile switching devices TD₁-TD₆, or the period of time between the occurrence of the student's manipulation of tactile switching devices TD₁-TD₆ and the auditory feedback received by the student in response thereto, or the like. For example, time delay switch 38 can be used to switch between an easy setting and a hard setting for the student. In the easier setting, the student can be given, for example, 500 ms to depress (and release) the combinations of pushbuttons PB₁-PB₆ required to correctly form or write the requested character, and in the hard setting the delay can be reduced to 200 ms. It will be noted that the specific examples just given of values for the time delay were determined by working with certain test cases including children with impaired and non-impaired motor control, but the embodiments disclosed herein are not limited to any specific values for the time delay settings. The time delay feature is useful for enforcing simultaneous pressing of pushbuttons PB₁-PB₆ by the student, as such is required in the use of an actual Braille writer. If simultaneous pressing does not occur, electronic circuitry EC (FIG. 8) of apparatus 10 can be configured to provide an auditory message indicating an incorrect entry (i.e., the combination of pushbuttons PB₁-PB₆ depressed by the student does not represent a Braille character) or a message for another letter that was not intended. This allows children, who become accustomed to apparatus 10, to receive instructional prompts without the need for constant instructor oversight. Time delay switch 38 is preferably mounted to rear side 14B of enclosure 14 to discourage the student from accidentally switching apparatus 10 into the harder mode, thereby avoiding potential frustration.

Record button 42, record/playback mode switch 44, and audio jack 46 are employed to record auditory outputs, such as prompts and/or feedback for the student, into a voice chip VC or other suitable sound or voice record/playback device provided with electronic circuitry EC (see FIG. 8). Record/playback mode switch 44 can be used to switch electronic circuitry EC between recording and playback modes, and record button 42 can be depressed while recording to enable voice chip VC to receive and store voice or sound data from an external source. For this purpose, audio jack 46 can be used to provide communication between voice chip VC and a microphone MP (FIG. 8), an external audio playback device (e.g., a CD player), a computer, or other suitable audio input device. Apparatus 10 can be configured to provide an auditory output for emission by speaker SP that indicates a change in the setting of record/playback mode switch 44 (e.g., “now in record mode”). Such auditory outputs can be stored in a memory register included with voice chip VC.

A suitable electronic control device such as a microprocessor, microcontroller MC, or the like provided with electronic circuitry EC (FIG. 8) coordinates the output of voice chip VC with the input provided by the student (i.e., the operation of pushbuttons PB₁-PB₆ of tactile switching devices TD₁-TD₆) in either the read or write modes of apparatus 10. An instructor or parent can select the words and/or sounds to be associated with corresponding Braille characters in response to successful formation of those characters by the student using tactile switching devices TD₁-TD₆. For example, if the student is prompted to form the letter “c” (either by the instructor or parent, or by the programmed auditory operation of apparatus 10 as controlled by microcontroller MC), and the student successfully manipulates tactile switching devices TD₁-TD₆ in the correct pattern or combination, voice chip VC will output an appropriate verification through speaker SP such as “c . . . cat . . . <meow>”. To maintain a sufficient level of interest and enjoyment in the learning process, the record mode can be employed to change specific auditory feedback responses (e.g., the response for “c” could be changed to “c . . . cricket . . . <chirp>”). Pre-recorded media such as compact disks or software can also be employed for this purpose, by connecting an appropriate playback instrument to audio jack 46. Moreover, recordings could be made with the student's own voice and selection of word and/or sound associations to generate further interest in the learning process and the use of apparatus 10.

As an example of recording auditory outputs into apparatus 10 as feedback for the student during the use of apparatus 10, an instructor, parent or student manipulates record/playback mode switch 44 to set apparatus 10 into its record mode which, as noted above, can result in an auditory response such as “now in record mode”. With swing arms SA₁ and SA₂ positioned in either the read or the write position, one or more of pushbuttons PB₁-PB₆ are actuated into the raised position in the Braille pattern corresponding to the character (e.g., “a”) for which a sound is to be recorded. The actuation of pushbuttons PB₁-PB₆ while in the record mode enables voice chip VC or microcontroller MC to identify the memory cell or memory location of voice chip VC into which the sound is to be copied. Next, record button 42 is depressed and, while record button 42 is held down, one or more sounds (e.g., a pronunciation of “a”, and/or “apple”, and/or a sound for “<crunch>”) are input into voice chip VC via an external device (e.g., microphone MP, CD player, or the like) connected to audio jack 46. This process is then repeated for other sounds to be recorded (e.g., “b”, “c”, . . . ; “1”, “2”, “3”, . . . ).

It can be appreciated that, depending on the desired configuration of electronic circuitry EC, one memory cell can be used to store all auditory output types of a single association (e.g., “a”, “apple”, “<crunch>”), or separate memory cells can be used to store each different type of auditory output associated with a particular character. In the case of using a single memory cells for all associated auditory output types, during the use of apparatus 10 in the playback mode, the setting of audio output selector switch 34 determines how long voice chip VC will play the auditory output stored in the selected memory cell. For instance, if audio output selector switch 34 is set to a “letter only” mode, voice chip VC will only play the first portion of the auditory output (e.g., “a”) and then stop. If, on the other hand, audio output selector switch 34 is set to a “letter+sound”mode, voice chip VC will play the entire recording stored as the selected memory location (e.g., “a”, “apple”, “<crunch>”). In the case of using different memory cells for different auditory output types, during the use of apparatus 10 in the playback mode, the setting of audio output selector switch 34 determines which memory cell will be accessed and played by voice chip VC in response to a particular user input effected through actuation of tactile switching devices TD₁-TD₆. For instance, if audio output selector switch 34 is set to a “letter only” mode, voice chip VC will access and play from the memory cell in which a single letter (e.g., “a”) is stored. If, on the other hand, audio output selector switch 34 is set to a “letter+sound” mode, voice chip VC will access and play from the memory cell in which all similarly associated auditory outputs are stored (e.g., “a”, “apple”, “<crunch>”).

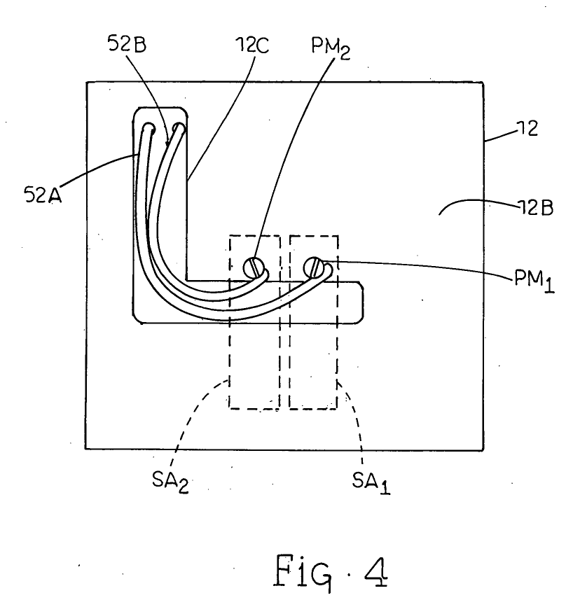

Referring to FIG. 4, an underside 12B of base 12 is illustrated. In this embodiment, underside 12B includes a cavity 12C providing a space for routing conduits 52A and 52B containing electrical wiring 54 (see FIGS. 7A and 7B) from respective swing arms SA₁ and SA₂ mounted on base 12 to electronic circuitry EC contained within enclosure 14. The electrical interface between pushbuttons PB₁-PB₆ of swing arms SA₁ and SA₂ and electronic circuitry EC is described in more detail below. A bottom plate or panel (not shown), constructed of wood, plexiglass or the like, can be mounted to underside 12B to enclose conduits 52A and 52B within cavity 12C.

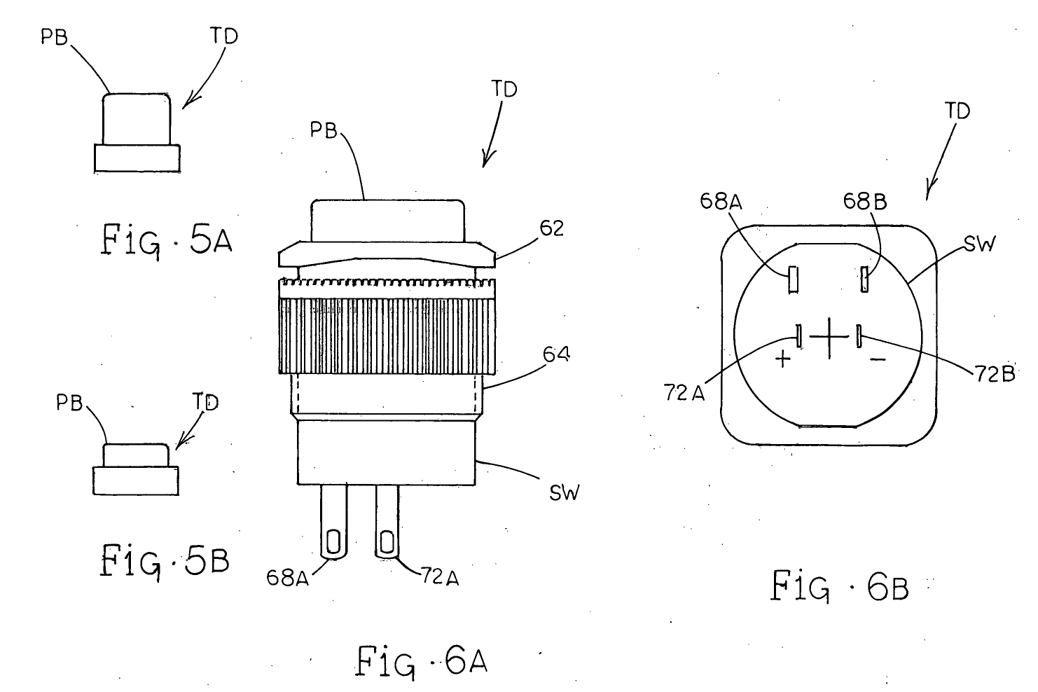

In advantageous embodiments, tactile switching devices TD₁-TD₆ are of the “latching” or “alternate action” type as those terms are understood by persons skilled in the art. A simplified illustration of one tactile switching device TD of this type is provided in FIGS. 5A and 5B. As appreciated by persons skilled in the art, pushbutton PB can be actuated between an OFF state and an ON state. Pushbutton PB is in a raised position while in the OFF state and in a lowered position while in the ON state. A user of apparatus 10 (e.g., a student or instructor) can cycle pushbutton PB from the ON state to the OFF state and vice versa by depressing and subsequently releasing pushbutton PB. That is, if pushbutton PB is in the raised state shown in FIG. 5A, depressing and releasing pushbutton PB locks pushbutton PB into the lowered state shown in FIG. 5B. Depressing and releasing pushbutton PB once again unlocks pushbutton PB and allows it to return to the raised state. Thus, pushbutton PB remains in either the raised or lowered position until such time as pushbutton PB is deliberately actuated to switch into the other state. In the context of the present embodiment, the raised position of a given pushbutton PB corresponding to a coordinate within the Braille cell represents the existence of a raised Braille dot at that coordinate, and the lowered position of pushbutton PB represents the absence of a raised Braille dot at that coordinate. For example, referring to FIG. 1A or 1B, depressing pushbutton PB₁ (corresponding to the top left dot of a Braille cell) into its raised position yields the Braille character for the letter “a”, depressing pushbuttons PB₁ and PB₂ (corresponding to the top left and middle left dots of a Braille cell) into their raised positions yields the Braille character for the letter “b”, and so on. It will be understood that the terms “ON” and “OFF” are used arbitrarily herein as they relate to the raised and lowered positions of pushbuttons PB₁-PB₆, and are not intended to limit either state of pushbuttons PB₁-PB₆ to a specific logic or binary state.

Referring to FIGS. 6A and 6B, a structural example of a tactile switching device TD is illustrated according to one embodiment. As shown in FIG. 6A, the exemplary tactile switching device TD includes a nut 62 and housing 64 or similar structure that facilitates mounting tactile switching device TD in a corresponding bore formed in swing arm SA₁ or SA₂. Mounting can be effected in any suitable manner, such as press-fitting, the use of splines or threads, or the like. In some embodiments, each tactile switching device TD can be mounted directly to base 12 in either the 3×2 or 1×6 arrangement, without the use of swing arms SA₁ and SA₂. In advantageous embodiments, however, each tactile switching device TD is mounted directly to a corresponding swing arm SA₁ or SA₂ to provide the ability to use apparatus 10 in either the read or write mode, as described above and illustrated in FIGS. 1A and 1B.

As also shown in FIGS. 6A and 6B, in addition to pushbutton PB, each tactile switching device TD includes a pushbutton switch SW. Pushbutton PB mechanically communicates with pushbutton switch SW in any manner suitable for enabling pushbutton PB to be manipulated by a user to cycle pushbutton switch SW between the ON and OFF states. As noted above, in advantageous embodiments, the interface between pushbutton PB and pushbutton switch SW is such as to realize a latching or alternate action type of design. Referring to FIG. 6B, pushbutton switch SW can include one or two pairs of conductive pins or other types of terminals 68A, 68B and 72A, 72B. One pair of terminals 68A and 68B are operatively associated with the switching of tactile switching device TD between the ON and OFF states. As an option, another pair of terminals 72A and 72B can be provided to switch an LED (FIG. 8) disposed within tactile switching device TD for illuminating its corresponding pushbutton PB, or disposed remotely from tactile switching device TD, such as at a panel mounted on apparatus 10 readily within sight of an instructor or parent. This option can serve as a visual aid for an instructor to provide an enhanced indication of whether pushbutton PB is in a raised or lowered position depending on how LED is connected. One example of a suitable tactile switching device TD or the latching or alternate action type is available as part #EG2543-ND from Digi-Key Corporation, Thief River Falls, Minn.

Referring to FIGS. 7A and 7B, one swing arm SA₂ is illustrated in detail, with the understanding that the other swing arm SA₁ can be the same or substantially similar in terms of structure and features. In advantageous embodiments, a recess 82 is formed in an underside of swing arm SA₂ to facilitate the routing of wiring 54 in a manner enabling swing arms SA₁ and SA₂ to pivot without damaging wiring 54. Thus, the bottom end of each pushbutton switch SW₄-SW₆ or at least its terminals 68A, 68B and 72A, 72B extend into or are exposed to recess 82, and wiring 54 from each pushbutton switch SW₄-SW₆ is disposed longitudinally along recess 82 toward pivot member PM₂. In the vicinity of pivot member PM₂, wiring 54 is generally coaxially grouped within conduit 52B adjacent to pivot member PM₂. Conduit 52B and pivot member PM₂ are run through separate, adjacent bores 92 and 94 formed in base 12, or alternatively are both run though the same bore in base 12. Conduit 52B extends through base 12 and is directed into the interior of enclosure 14 for connection to electronic circuitry EC by any suitable means. In the example illustrated in FIG. 7B, wiring 54 and conduits 52A (not specifically shown) and 52B from both swing arms SA₁ and SA₂ terminate at a D-sub male connector 102 for removable connection with a female connector 104 communicating with electronic circuitry EC via a ribbon cable 106.

In FIG. 7B, pushbuttons PB₄-PB₆ are shown in the raised position. In one embodiment, the tops of pushbuttons PB₄-PB₆ when in the raised position are elevated ⅛ inch or thereabouts above an upper surface 112 of swing arm SA₂. Other elevation values can be chosen for the raised position, so long as pushbuttons PB₄-PB₆ are capable of providing a raised dot effect that can be easily sensed by the student and distinguished from the lowered position. In one embodiment, while in the lowered position, each pushbutton PB₄-PB₆ is flush or substantially flush with upper surface 112 of swing arm SA₂, thereby clearly indicating the absence of a raised dot at the coordinate of that particular pushbutton PB₄-PB₆. If desired, swing arm SA₂, or at least its upper surface 112, can be covered with a laminate material to provide a smooth surface flush with pushbuttons PB₄-PB₆ while in the lowered position.

FIG. 8 schematically illustrates electronic circuitry EC included with apparatus 10. In advantageous embodiments, electronic circuitry EC is housed within enclosure 14 (see FIGS. 1A, 1B and 7B) and mounted, for instance, to a suitable printed board PCB. As noted above, electronic circuitry EC includes microcontroller MC and voice chip VC, which communicate with each other by known means. One non-limiting example of a suitable microcontroller MC is a 28/40-pin, 8-bit, CMOS-based chip with flash program memory, data memory (RAM) and EEPROM data memory, and a 35-single-word instruction set, which is available as part #PIC16F877-20/P-ND from Digi-Key Corporation. One non-limiting example of a suitable voice chip VC is a CMOS-based voice record/playback chip with flash memory and multiple-message and non-volatile multi-level storage capability, which is available as part #ISD4004-08MP-ND from Digi-Key Corporation. As illustrated in FIG. 8, microcontroller MC receives inputs from pushbutton switches SW₁-SW₆, audio output selector switch 34, time delay switch 38, record button 42, and record/playback mode switch 44. In some embodiments, pushbutton switches SW₁-SW₆, communicate with respective light-emitting diodes LED₁-LED₆ as noted above. Voice chip VC has an analog differential input connection 122 that can be capacitively coupled to microphone MP or other suitable audio input devices as noted above for receiving auditory input through audio jack 46 (FIG. 3). Auditory output from voice chip VC is capacitively coupled to volume control 36, which is a potentiometer that controls the gain achieved by an LM386 op-amp 124. The output from op-amp 124 is sent to speaker SP. As further shown in FIG. 8, a +3V regulator REG₁ and a +5V regulator REG₂ are provided to supply power to voice chip VC and microcontroller MC, respectively, from a +9V battery source. As appreciated by persons skilled in the art, electronic circuitry EC could be adapted for receiving power from a standard line voltage source as well. All other components and functions of electronic circuitry EC as schematically shown in FIG. 8 are readily understood by persons skilled in the art, and therefore need not be described further herein.

An example of the operation of apparatus 10 will now be described, with the understanding that apparatus 10, as described above, is highly flexible and reconfigurable such that it can be tailored to a variety of different types of techniques for providing and enhancing the instruction of Braille communication. First, either before or after apparatus 10 is initially powered up, the user (student, parent, instructor, etc.) ensures that apparatus 10 is set to the proper operating modes. If new pronunciations, sounds, and/or other types of auditory prompts or feedback are to be recorded, record/playback mode switch 44 is set to record mode and the recording techniques described above can then be performed. If no recordings are to be made, apparatus 10 is set to the playback (i.e., instruction) mode by setting record/playback mode switch 44 to playback mode. In addition, the user selects the type of auditory output (e.g., letter only, letter and word, letter and word and sound) to be emitted from speaker SP by setting audio output selector switch 34 appropriately. At this time, volume and time delay settings can also be made using volume control 36 and time delay switch 38, respectively. Also, the read or write mode for apparatus 10 is selected, and swing arms SA₁ and SA₂ are rotated as necessary to set apparatus 10 into the position corresponding to the selected mode.

Once apparatus 10 has been set up as described above, a Braille instructive session can be initiated, during which time any input made by the student via manipulation of pushbuttons PB₁-PB₆ (and thus pushbutton switches SW₁-SW₆) will result in an appropriate auditory output sounded through speaker SP. Apparatus 10 can be adapted for use in connection with any type of prompt for the student to make a user input. For instance, an instructor or parent can provide the prompts, such as by requesting that the student form a certain character using pushbuttons PB₁-PB₆. Alternatively, the instructor or parent can play a recording from an external device (e.g., a CD player) that provides a series of prompts (i.e., a predetermined lesson) for the student (e.g., “now please type the letter ‘a’”), with a sufficient amount of time transpiring between each prompt to allow the student to manipulate pushbuttons PB₁-PB₆ in response to the prompt and to receive the resulting auditory output from speaker SP. In addition, apparatus 10 can be configured such that prompts are stored and played by voice chip VC, as well as the auditory outputs, all of which can be controlled by microcontroller MC. Finally, apparatus 10 can be used without any external prompts or predetermined lessons, enabling the student to engage in self-practice and exploration.

In the operation of electronic circuitry, manipulation of one or more pushbuttons PB₁-PB₆ of tactile switching devices TD₁-TD₆ into the raised position results in activation of one or more corresponding pushbutton switches SW₁-SW₆. This user input results in one or more input signals being sent over wiring 54 (FIG. 7B) to microcontroller MC. If microcontroller MC interprets the received user input as corresponding to a digital value representing a particular Braille character, microcontroller MC sends a control signal or other appropriate electronic output to voice chip VC, after expiration of the time delay delimited by time delay switch 38, as necessary to access the memory cell in voice chip VC containing the auditory output corresponding to the intended Braille character. In response, voice chip VC plays the auditory output, of the type delimited by audio output selector switch 34, through speaker SP to provide verification to the student that the student has correctly formed the intended Braille character using pushbuttons PB₁-PB₆. If, after expiration of the time delay, microcontroller MC fails to recognize the user input as corresponding to a particular Braille character, microcontroller MC can be adapted to cause voice chip VC to play an auditory output indicative of this error. Electronic circuitry EC can be configured to be reset in response to receiving a user input generated by returning all pushbuttons PB₁-PB₆ to the lowered position.

It will be understood that various details of the invention may be changed without departing from the scope of the invention. Furthermore, the foregoing description is for the purpose of illustration only, and not for the purpose of limitation, as the invention is defined by the claims as set forth hereinafter.

1. An apparatus for use in instructing a user to communicate in Braille, comprising:
(a) a frame;
(b) a plurality of tactile switching devices mounted at the frame, each tactile switching device depressible by the user between a raised position for emulating a raised Braille dot and a lowered position; and
(c) electronic circuitry supported by the frame and comprising an audio output device, the circuitry communicating with the switching devices for producing an auditory output for emission by the audio output device in response to a combination of switching devices selectively activated by a user, wherein the auditory output corresponds to the Braille character represented by the combination of activated switching devices.

2. The apparatus according to claim 1 comprising a pair of arms coupled to the frame, each arm supporting three of the tactile switching devices, wherein at least a portion of each switching device is raised above an upper surface of a corresponding arm when at the raised position.

3. The apparatus according to claim 2 wherein the pair of arms are pivotably coupled to the frame and rotatable along the frame between a first position at which the arms are generally parallel to each other and the switching devices are arranged in a 3×2 array of Braille dots for emulating a Braille cell, and a second position at which the arms are pivoted outwardly from each other and the switching devices are arranged in a 1×6 row of Braille dots for emulating a Braille writer.

4. The apparatus according to claim 2 wherein each arm comprises a pivot member extending into a corresponding bore in the frame, and each arm is pivotable about an axis of its respective pivot member.

5. The apparatus according to claim 1 wherein the circuitry comprises:
(a) a control device for receiving a user input produced by the combination of switching devices selectively activated by the user, and for sending a control signal based on the user input received; and
(b) a playback device for storing a plurality of different auditory outputs, receiving a control signal sent from the control device, and sending a selected auditory output to the audio output device based on the control signal received from the control device.

6. The apparatus according to claim 5 wherein the control device comprises a microcontroller.

7. The apparatus according to claim 5 comprising an audio output selector switch communicating with the control device for selecting a type of auditory output to be sent from the playback device from a plurality of different types of auditory outputs stored in the playback device.

8. The apparatus according to claim 7 wherein, for each user input, the plurality of different types of auditory outputs are selected from the group consisting of a pronunciation of a character corresponding to the user input, a pronunciation of a word beginning with a character corresponding to the user input, a sound associated with a word beginning with a character corresponding to the user input, and combinations thereof.

9. The apparatus according to claim 5 comprising a time delay switch communicating with the control device for selecting a value for a time delay between receiving the user input by the control device and sending the selected auditory output by the playback device.

10. The apparatus according to claim 5 comprising a record/playback switch communicating with the control device for selectively switching the electronic circuitry between a playback mode enabling the electronic circuitry to produce the auditory output in response to activation of the switching devices by the user, and a record mode enabling auditory outputs to be received by the playback device and stored thereby.

11. The apparatus according to claim 10 comprising an audio input connection communicating with the playback device for communicating with an audio input device.

12. The apparatus according to claim 11 wherein the audio input connection comprises an audio jack mounted to the frame.

13. The apparatus according to claim 11 comprising a record button communicating with the control device for selectively enabling the playback device to record an auditory input received from audio input connection.

14. The apparatus according to claim 5 wherein the playback device comprises a voice chip.

15. The apparatus according to claim 1 comprising an audio output selector switch communicating with the circuitry for selecting a type of auditory output to be produced by the circuitry from a plurality of different types of auditory outputs stored by the circuitry.

16. The apparatus according to claim 1 comprising a time delay switch communicating with the circuitry for selecting a value for a time delay between receiving a user input by the circuitry resulting from activation of the switching devices, and emitting the audio output by the audio output device.

17. The apparatus according to claim 1 comprising a record/playback switch communicating with the circuitry for selectively switching the circuitry between a playback mode enabling the circuitry to produce the auditory output in response to activation of the switching devices by the user, and a record mode enabling the circuitry to receive and store audio outputs.

18. An apparatus for use in instructing a user to communicate in Braille, comprising:
(a) a frame;
(b) a plurality of switching devices for selective activation by a user to represent one or more raised Braille dots;
(c) a pair of arms pivotably coupled to the frame, each arm supporting at least three switching devices, wherein the pair of arms are rotatable along the frame between a first position at which the arms are generally in parallel relation and the switching devices are arranged in a 3×2 array of Braille dots for emulating a Braille cell, and a second position at which the arms are pivoted outwardly from each other in a 1×6 row of Braille dots for emulating a Braille writer; and
(d) electronic circuitry supported by the frame and comprising an audio output device, the circuitry communicating with the switching devices for producing an auditory output for emission by the audio output device in response to a combination of switching devices selectively activated by a user, wherein the auditory output corresponds to the Braille character represented by the combination of activated switching devices.

19. The apparatus according to claim 18 wherein the circuitry comprises:
(a) a control device for receiving a user input produced by the combination of switching devices selectively activated by the user, and for sending a control signal based on the user input received; and
(b) a playback device for storing a plurality of different auditory outputs, receiving a control signal sent from the control device, and sending a selected auditory output to the audio output device based on the control signal received from the control device.

20. The apparatus according to claim 19 comprising an audio output selector switch communicating with the control device for selecting a type of auditory output to be sent from the playback device from a plurality of different types of auditory outputs stored in the playback device.

21. The apparatus according to claim 19 comprising a time delay switch communicating with the control device for selecting a value for a time delay between receiving the user input by the control device and sending the selected auditory output by the playback device.

22. The apparatus according to claim 19 comprising a record/playback switch communicating with the control device for selectively switching the electronic circuitry between a playback mode enabling the electronic circuitry to produce the auditory output in response to activation of the switching devices by the user, and a record mode enabling auditory outputs to be received by the playback device and stored thereby.

23. The apparatus according to claim 22 comprising an audio input connection communicating with the playback device for communicating with an audio input device.

24. The apparatus according to claim 23 comprising a record button communicating with the control device for selectively enabling the playback device to record an auditory input received from audio input connection.

25. The apparatus according to claim 18 comprising an audio output selector switch communicating with the circuitry for selecting a type of auditory output to be produced by the circuitry from a plurality of different types of auditory outputs stored by the circuitry.

26. The apparatus according to claim 18 comprising a time delay switch communicating with the circuitry for selecting a value for a time delay between receiving a user input by the circuitry resulting from activation of the switching devices, and emitting the audio output by the audio output device.

27. The apparatus according to claim 18 comprising a record/playback switch communicating with the circuitry for selectively switching the circuitry between a playback mode enabling the circuitry to produce the auditory output in response to activation of the switching devices by the user, and a record mode enabling the circuitry to receive and store audio outputs.

28. An apparatus for use in instructing a user to communicate in Braille, comprising:
(a) a frame;
(b) a plurality of tactile switching devices, each tactile switching device depressible between a lowered position and a raised position;
(c) a pair of arms pivotably coupled to the frame, each arm supporting at least three tactile switching devices wherein, for the raised position of each switching device, at least a portion of the switching device is raised above an upper surface of its corresponding arm for emulating a raised Braille dot, and the pair of arms are rotatable along the frame between a first position at which the arms are generally in parallel relation and the switching devices are arranged in a 3×2 array of Braille dots for emulating a Braille cell, and a second position at which the arms are pivoted outwardly from each other in a 1×6 row of Braille dots for emulating a Braille writer; and
(d) electronic circuitry supported by the frame and comprising an audio output device, the circuitry communicating with the switching devices for producing an auditory output for emission by the audio output device in response to a combination of switching devices selectively activated by a user, wherein the auditory output corresponds to the Braille character represented by the combination of activated switching devices.

29. The apparatus according to claim 28 wherein the circuitry comprises:
(a) a control device for receiving a user input produced by the combination of switching devices selectively activated by the user, and for sending a control signal based on the user input received; and
(b) a playback device for storing a plurality of different auditory outputs, receiving a control signal sent from the control device, and sending a selected auditory output to the audio output device based on the control signal received from the control device.

30. The apparatus according to claim 29 comprising an audio output selector switch communicating with the control device for selecting a type of auditory output to be sent from the playback device from a plurality of different types of auditory outputs stored in the playback device.

31. The apparatus according to claim 30 wherein, for each user input, the plurality of different types of auditory outputs are selected from the group consisting of a pronunciation of a character corresponding to the user input, a pronunciation of a word beginning with a character corresponding to the user input, a sound associated with a word beginning with a character corresponding to the user input, and combinations thereof.

32. The apparatus according to claim 29 comprising a time delay switch communicating with the control device for selecting a value for a time delay between receiving the user input by the control device and sending the selected auditory output by the playback device.

33. The apparatus according to claim 29 comprising a record/playback switch communicating with the control device for selectively switching the electronic circuitry between a playback mode enabling the electronic circuitry to produce the auditory output in response to activation of the switching devices by the user, and a record mode enabling auditory outputs to be received by the playback device and stored thereby.

34. The apparatus according to claim 28 comprising an audio output selector switch communicating with the circuitry for selecting a type of auditory output to be produced by the circuitry from a plurality of different types of auditory outputs stored by the circuitry.

35. The apparatus according to claim 28 comprising a time delay switch communicating with the circuitry for selecting a value for a time delay between receiving a user input by the circuitry resulting from activation of the switching devices, and emitting the audio output by the audio output device.

36. The apparatus according to claim 28 comprising a record/playback switch communicating with the circuitry for selectively switching the circuitry between a playback mode enabling the circuitry to produce the auditory output in response to activation of the switching devices by the user, and a record mode enabling the circuitry to receive and store audio outputs.

37. The apparatus according to claim 36 comprising an audio input connection communicating with the playback device for communicating with an audio input device.

38. A method for instructing a person in communicating in Braille, comprising:
(a) providing a plurality of tactile switching devices, each switching device actuatable between a raised position that can be sensed by a person as a raised Braille dot and a lowered position that can be sensed as the absence of a raised Braille dot; and
(b) in response to a combination of switching devices actuated into respective raised positions, providing an auditory output for the person corresponding to the Braille character represented by the combination of switching devices actuated.

39. The method according to claim 38 comprising arranging the tactile switching devices into a 3×2 Braille cell, wherein actuating the combination of switching devices into respective raised positions enables the person to learn to read Braille characters.

40. The method according to claim 38 comprising arranging the tactile switching devices into a 1×6 row emulating a keyboard for a Braille writer, wherein actuating the combination of switching devices into respective raised positions enables the person to learn to write Braille characters.

41. The method according to claim 38 comprising providing a pair of arms, each arm supporting at least three of the tactile switching devices, and rotating the arms between a first position at which the arms are generally in parallel relation and the switching devices are arranged in a 3×2 array of Braille dots for emulating a Braille cell, and a second position at which the arms are pivoted outwardly from each other in a 1×6 row of Braille dots for emulating a Braille writer.

42. The method according to claim 38 comprising, in response to actuation of the combination of switching devices, causing the tactile switching devices to transmit a user input signal to an electronic control device and, based on the user input signal received, causing the electronic control device to select the auditory output to be played back to the person indicative of the Braille character corresponding to the combination of switching devices actuated.

43. The method according to claim 42 wherein causing the electronic control device to select the auditory output to be played back comprises accessing a memory in which a plurality of different auditory outputs are stored.

44. The method according to claim 43 wherein the memory is disposed in a playback device and, after the selected auditory output has been accessed, the method comprises causing the playback device to send the selected auditory output to an audio output device for emission thereby.

45. The method according to claim 38 comprising selecting a type of audio output to be provided from a plurality of different types of audio outputs stored in circuitry communicating with the tactile switching devices.

46. The method according to claim 45 wherein, for the combination of actuated switching devices, the plurality of different types of audio outputs are selected from the group consisting of a pronunciation of the character corresponding to the combination of actuated switching devices, a pronunciation of a word beginning with a character corresponding to the combination of actuated switching devices, a sound associated with a word beginning with a character corresponding to the combination of actuated switching devices, and combinations thereof.

47. The method according to claim 38 comprising selecting a length of a delay to transpire between the actuation of the combination of switching devices and the providing of the auditory output corresponding to the combination.

48. The method according to claim 38 comprising recording a plurality of auditory outputs into electronic circuitry communicating with the switching devices, wherein each auditory output corresponds to the Braille character represented by a specific actuatable combination of switching devices.

49. A method for instructing a person in communicating in Braille, comprising:
(a) providing a pair of arms, each arm supporting at least three tactile switching devices, wherein the switching devices can be sensed by touch and selectively actuated for emulating patterns of raised Braille dots;
(b) rotating the pair of arms between a first position at which the arms are generally in parallel relation and the switching devices are arranged in a 3×2 array of Braille dots for emulating a Braille cell, and a second position at which the arms are pivoted outwardly from each other in a 1×6 row of Braille dots for emulating a Braille writer; and
(c) in response to a combination of switching devices actuated, providing an auditory output for the person corresponding to the Braille character represented by the combination of switching devices actuated.

50. The method according to claim 49 comprising, in response to actuation of the combination of switching devices, causing the tactile switching devices to transmit a user input signal to an electronic control device and, based on the user input signal received, causing the electronic control device to select the auditory output to be played back to the person indicative of the Braille character corresponding to the combination of switching devices actuated.

51. The method according to claim 50 wherein causing the electronic control device to select the auditory output to be played back comprises accessing a memory in which a plurality of different auditory outputs are stored.

52. The method according to claim 51 wherein the memory is disposed in a playback device and, after the selected auditory output has been accessed, the method comprises causing the playback device to send the selected auditory output to an audio output device for emission thereby.

53. The method according to claim 49, comprising selecting a type of audio output to be provided from a plurality of different types of audio outputs stored in circuitry communicating with the tactile switching devices.

54. The method according to claim 53 wherein, for the combination of actuated switching devices, the plurality of different types of audio outputs are selected from the group consisting of a pronunciation of the character corresponding to the combination of actuated switching devices, a pronunciation of a word beginning with a character corresponding to the combination of actuated switching devices, a sound associated with a word beginning with a character corresponding to the combination of actuated switching devices, and combinations thereof.

55. The method according to claim 49 comprising selecting a length of a delay to transpire between the actuation of the combination of switching devices and the providing of the auditory output corresponding to the combination.

56. The method according to claim 49 comprising recording a plurality of auditory outputs into electronic circuitry communicating with the tactile switching devices, wherein each auditory output corresponds to a Braille character represented by a specific actuatable combination of switching devices.
